(19) United States
(12) Patent Application Publication
(10) Pub. No.: US 2015/0220012 A1
(43) Pub. Date: Aug. 6, 2015

(54) Hyperpigmented Magenta Toner

(71) Applicant: Xerox Corporation, Norwalk, CT (US)

(72) Inventors: Padam K Angra, Pittsford, NY (US); Samir Kumar, Pittsford, NY (US); Christopher M Wolfe, Rochester, NY (US); Brendan H Williamson, Rochester, NY (US)

(73) Assignee: Xerox Corporation, Norwalk, CT (US)

(21) Appl. No.: 14/174,660

(22) Filed: Feb. 6, 2014

(51) Int. Cl. G03G 9/09

(52) U.S. Cl. CPC G03G 9/092; G03G 9/091

(57) ABSTRACT

Hyperpigmented magenta toner, that is indistinguishable from standard and conventional magenta toner, contains PR122 and PR260 in a 56:44 weight ratio and can be used with reduced TMA as compared to conventional magenta toner.

### FIELD

Hyperpigmented magenta toner particles; developers comprising said magenta Loner particles; devices comprising said magenta toner particles and developers; imaging device components comprising said toner particles and developers; imaging devices comprising said developers; and so on are described.

### BACKGROUND

CMYK is a color model of cyan, magenta, yellow and black. The CMYK model works by partially or entirely masking certain colors of a light or white background (that is, absorbing and scattering particular wavelengths of light). Thus, white is the natural color of the background while black results from a full combination of the colors. Deeper black tones and unsaturated and dark colors can be produced by substituting black for the combination of cyan, magenta and/or yellow. CMYK is an example of a model called, “subtractive,” because colors subtract brightness and colors from a light or white background. Photocopies or prints, such as, a print on white paper, are examples of display modes that are based on a subtractive color model as generally the image is presented on a lighter background, such as, white paper.

The prevalent use of magenta in the CMYK scheme makes magenta toner desirable and necessary.

However, there are limitations in reproducing certain colors and in reproducing colors that are similar in hue. Moreover, color characteristics can change depending, for example, on the medium bearing or presenting the color; the ancillary or accessory ingredients in a composition containing a colorant, such as, a dye, a pigment or a lake pigment; the compatibility of some colorants with a manufacturing process or reagents used therein; the degree of pigment loading; and so on.

Therefore, it is desirable to have a hyperpigmented magenta toner for use, for example, in color imaging to complement existing toners, and to reduce toner usage, production cost and printer run cost.

### SUMMARY

The instant disclosure provides combination of PR122 and PR269 in a 56/44 ratio by weight for producing hyperpigmented magenta toner particles. When printed on DCEG paper (120 gsm) at a toner mass area (TMA) or 0.35 mg/cm², the toner of interest has a color with a difference below the level of human perception, a ΔE₂₀₀₀ of less than 2, relative to a conventional magenta toner with a 50:50 ratio of PRI22:PR269 similarly printed on DCEG 120 gsm paper at a TMA of 0.45 mg/cm².

In embodiments, a toner of interest comprises at least one resin; and colorants consisting of pigment red (PR) 122 and PR 269 in a ratio of 56:44 by weight and a total colorant amount of 11.8 wt %, wherein an image comprising said toner in a toner mass area (TMA) of 0.35 mg/cm² when compared to an image comprising a magenta toner consisting of 9 wt % total pigment in a 50:50 weight ratio of PR122:PR269 in a TMA of 0.45 mg/cm² comprises a ΔE₂₀₀₀ of less than about 2.

In embodiments, a toner composition of interest can be a toner produced by an emulsion aggregation method, comprising, for example, a styrene or acrylate polymer or a polyester resin. A polyester resin can comprise amorphous and, optionally, a crystalline resin. Multiple amorphous resins can be used, such as, a low molecular weight amorphous resin and a high molecular weight amorphous resin.

Those and other embodiments were achieved in the development of a hyperpigmented magenta toner equivalent in color to standard magenta toners.

### DETAILED DESCRIPTION

### I. Introduction

A toner of the instant disclosure is a magenta toner suitable for use, for example, in a color image reproducing device. The hyperpigmented magenta toners of interest provide color similar to or identical to a standard magenta toner but can be applied in lower amounts.

A commercially available conventional, standard magenta toner is comprised of pigment red (PR) 269 and PR122 in a 1:1 weight ratio with a total pigment amount of 9 wt % of the toner.

An attempted hyperpigmented (HY) magenta toner retains that 1:1 ratio of PR122:PR269 but at increased loading of 13.05 pph of toner weight, which is 1.45 times the amount of total pigment found in the conventional magenta toner. However, when developed at a TMA of 0.35 mg/cm², the HY magenta toner with 1.45× the amount of total pigment containing the 1:1 ratio of PR122:PR269 pigments presented with significant color shift, which is unacceptable for commercial use.

The present disclosure provides for a hyperpigmented magenta toner with the total pigment level that is 1.31 times that found in conventional toner (containing about 11.8 wt % total pigment) and the PR122/PR269 ratio is 56/44 by weight. The inventive toner, when developed at 0.35 mg/cm² TMA, matches the color of conventional magenta toner developed at 0.45 mg/cm² TMA resulting in acceptable image quality (IQ) and standard color compliance. The ΔE₂₀₀₀ between the HY toner of interest and conventional magenta toner is under two, and hence, any differences between the inventive HY toner and conventional magenta toner are indistinguishable to the human eye.

As known, the error or variability factor, ΔE₂₀₀₀, converts CIELAB color data (L*, a* and b*) for a pair of colors into a single value expressing the “distance,” between the colors, and can be used as a measure of color difference or similarity. The formula for calculating ΔE₂₀₀₀ uses weighting to compensate for variation in the ability of the human eye to discriminate closely related shades within particular regions of the visible spectrum. When the ΔE₂₀₀₀ of two colors is less than 3, the two colors generally are considered to be indistinguishable to the human eye. (Color Research and Application in 2003 (Johnson & Fairchild, “A top down description of S-CIELAB and CIE ΔE₂₀₀₀,” Color Res Appl, 28:425-435, 2003).

Unless otherwise indicated, all numbers expressing quantities, conditions and so forth used in the specification and claims are to be understood as being modified in all instances by the term, “about.” “About,” is meant to indicate a variation of no more than 10% from the stated value. Also used herein is the term, “equivalent,” “similar,” “essentially,” “substantially,” “approximating” and “matching,” or grammatic variations thereof, have generally acceptable definitions or at the least, are understood to have the same meaning as, “about.”

### II. Toner Particles

Toner particles of interest comprise a reddish pigment (PR269) and a purplish pigment (PR122) and other components used to make a magenta toner as known in the art, such as, one or more resins, a wax and so on.

A. Components

1. Resin

Toner particles of the instant disclosure include a resin for forming a particulate containing or carrying the colorants of a toner of interest for use in certain imaging devices. Generally any resin or suitable monomer or monomers that are induced to polymerize to form a polymer or a copolymer, which may carry or entrap reagents present in a monomer solution, can be used in a toner of interest. Suitable monomers useful in forming a resin include, but are not limited to, styrenes, acrylates, methacrylates, butadienes, isoprenes, acrylic acids, methacrylic acids, acrylonitriles, esters, diesters, diisocyanates, combinations thereof and the like. Any monomer may be used depending on the particular polymer or resin desired in a toner particle. Styrenes and/or acrylates, for example, can be used for applications requiring gloss, and polyesters, for example, can be used for applications requiring low melting temperature.

One, two or more polymers may be used in forming a toner or toner particle. Where two or more polymers are used, the polymers may be in any suitable ratio (e.g., weight ratio) such as, from about 1% (first polymer)/99% (second polymer) to about 99% (first polymer)/1% (second polymer), in embodiments from about 10% (first polymer)/90% (second polymer) to about 90% (first polymer)/10% (second polymer).

In embodiments, a suitable toner may include at least two amorphous resins, a high molecular weight resin (HMW) and a low molecular weight resin (ILMW). As used herein, an HMW amorphous resin may have an MW of from about 35,000 to about 150,000, from about 45,000) to about 140,000, and an LMW amorphous resin may have an MW of from about 10,000 to about 30,000, from about 15,000 to about 25,000. When LMW and HMW resins are used, the LMW resin can be present in an amount from about 41 wt % to about 46 wt %, from about 42 wt % to about 45 wt %, from about 43 wt % to about 44 wt %; and the HMW resin can be present in an amount from about 26 wt % to about 32 wt %, from about 27 wt % to about 31 wt %, from about 28 wt % to about 30 wt %.

The resin(s) may be present in an amount from about 76 wt/o to about 82 wt %, from about 77 wt % to about 81 wt %, from about 78 wt % to about 80 wt % by weight of the toner particles on a solids basis.

a. Acrylates

In embodiments, the resin, comprises, for example, those based on styrene acrylates, styrene butadienes and styrene methacrylates, such as, poly(styrene/alkyl acrylate), poly(styrene-1,3-diene), poly(styrene/alkyl methacrylate), poly(styrene/alkyl acrylate/acrylic acid), poly(styrene-1,3-diene/acrylic acid), poly(styrene/alkyl methacrylate/acrylic acid), poly(alkyl methacrylate/alkyl acrylate), poly(alkyl methacrylate/aryl acrylate), poly(aryl methacrylate/alkyl acrylate), poly(alkyl methacrylate/acrylic acid), poly(styrene/alkyl acrylate/acrylonitrile/acrylic acid), poly(styrene-1,3-diene/acrylonitrile/acrylic acid), poly(alkyl acrylate/acrylonitrile/acrylic acid), poly(styrene/butadiene), poly(methylstyrene/butadiene), poly(methyl methacrylate/butadiene), poly(ethyl methacrylate/butadiene), poly(propyl methacrylate/butadiene), poly(butyl methacrylate/butadiene), poly(methyl acrylate/butadiene), poly(ethyl acrylate/butadiene), poly(propyl acrylate/butadiene), poly(butyl acrylate/butadiene), poly(styrene/isoprene), poly(methylstyrene/isoprene), poly(methyl methacrylate/isoprene), poly(ethyl methacrylate/isoprene), poly(propyl methacrylate/isoprene), poly(butyl methacrylate/isoprene), poly(methyl acrylate/isoprene), poly(ethyl acrylate/isoprene), poly(propyl acrylate/isoprene), poly(butyl acrylate/isoprene), poly(styrene/propyl acrylate), poly(styrene/butyl acrylate), poly(styrene/butadiene/acrylic acid), poly(styrene/butadiene/methacrylic acid), poly(styrene/butadiene/acrylonitrile/acrylic acid), poly(styrene/butyl acrylate/acrylic acid), poly(styrene/butyl acrylate/methacrylic acid), poly(styrene/butyl acrylate/acrylonitrile), poly(styrene/butyl acrylate/acrylonitrile/acrylic acid), poly(styrene/butadiene), poly(styrene/butyl methacrylate), poly(styrene/butyl acrylate/acrylic acid), poly(styrene/butyl methacrylate/acrylic acid), poly(butyl methacrylate/butyl acrylate), poly(butyl methacrylate/acrylic acid), poly(acrylonitrile/butyl acrylate/acrylic acid) and combinations thereof. The polymers may be block, random or copolymers, see, for example, U.S. Pat. Nos. 5,462,828; 6,120,967; 7,713,668; and 7,759,039.

b. Polyester Polymers

In embodiments, the polymer may be a polyester polymer. Suitable polyester polymers include, for example, those which are sulfonated, non-sulfonated, crystalline, amorphous, combinations thereof and the like. The polyester polymers may be linear, branched, combinations thereof and the like. Polyester polymers may include those described, for example, in U.S. Pat. Nos. 6,593,049; 7,749,672; and 6,756,176, the disclosure of each of which hereby is incorporated by reference in entirety.

Suitable matrices include an amorphous polyester polymer, a crystalline polyester polymer or a mixture of an amorphous polyester polymer and a crystalline polyester polymer, for example, as described in U.S. Pat. Nos. 6,830,860; 7,754,406; and 7,781,138, the disclosure of each of which hereby is incorporated by reference in entirety.

When a mixture is used, the ratio of crystalline polyester polymer to amorphous polyester polymer can be in the range from about 1:99 to about 10:90; from about 3:97 to about 9:91; from about 5:95 to about 8:92.

i. Diol-Diacid/Diester Reactants

In embodiments, the resin may be a polyester polymer formed by reacting a diol with a diacid or diester, optionally, in the presence of a catalyst.

Suitable diols include aliphatic diols having from about 2 to about 36 carbon atoms, such as 1,2-ethanediol, 1,3-propanediol, 1,4-butanediol, 1,3-butanediol, 1,2-butanediol, 1,5-pentanediol, 1,6-hexanediol, 1,7-heptanediol, 1,8-octanediol, 1,9-nonanediol, 1,10-decanediol, 1,12-dodecanediol, ethylene glycol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cyclohexanediol, diethylene glycol, bis(2-hydroxyethyl)oxide, dipropylene glycol, dibutylene glycol, combinations thereof and the like.

The diol may be, for example, selected in an amount of from about 40 to about 60 wt %, from about 42 to about 55 wt %, from about 45 to about 53 wt % of a polyester polymer-forming reaction mixture.

Examples of diacids or diesters for preparing a polyester include oxalic acid, succinic acid, glutaric acid, adipic acid, suberic acid, azelaic acid, fumaric acid, maleic acid, dodecanedioic acid, sebacic acid, phthalic acid, isophthalic acid, itaconic acid, dodecylsuccinic acid, terephthalic acid, naphthalene-2,6-dicarboxylic acid, pimelic acid, naphthalene-2,7-dicarboxylic acid, cyclohexane dicarboxylic acid, malonic acid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, mesaconic acid, a diester or anhydride thereof, and combinations thereof.

The diacid may be used in an amount of, for example, from about 60 to about 40 wt %, from about 58 to about 45 wt %, from about 55 to about 47 wt % of a resin-forming reaction mixture.

Polycondensation catalysts which may be used in the polyester polymer reaction include tetraalkyl titanates; dialkyltin oxides, such as, dibutyltin oxide; tetraalkyltins, such as, dibutyltin dilaurate; dialkyltin oxide hydroxides, such as, butyltin oxide hydroxide; aluminum alkoxides, alkyl zinc, dialkyl zinc, zinc oxide, stannous oxide or combinations thereof. Such catalysts may be used in amounts of, for example, from about 0.01 wt % to about 5 wt % based on the amount of starting diacid or diester in the reaction mixture used to generate the polyester polymer, with a commensurate reduction in amounts of the other reactants.

ii. Crystalline Polyester Polymers

Examples of crystalline polyester polymers include polyamides, polyimides, polyolefins, polyethylenes, polybutylenes, polyisobutyrates, ethylene-propylene copolymers, ethylene-vinyl acetate copolymers, polypropylenes, mixtures thereof and so on. Crystalline polyester polymers include poly(ethylene adipate), poly(propylene adipate), poly(butylene adipate), poly(pentylene adipate), poly(hexylene adipate), poly(octylene adipate), poly(ethylene succinate), poly(propylene succinate), poly(butylene succinate), poly(pentylene succinate), poly(hexylene succinate), poly(octylene succinate), poly(ethylene sebacate), poly(propylene sebacate), poly(butylene sebacate), poly(pentylene sebacate), poly(hexylene sebacate), poly(octylene sebacate), alkali copoly(5-sulfoisophthalate)-(ethylene adipate), poly(decylene sebacate), poly(decylene decanoate), poly(ethylene decanoate), poly(ethylene dodecanoate), poly(nonylene sebacate), poly(nonylene decanoate), copoly(ethylene fumarate)-(ethylene sebacate), copoly(ethylene fumarate)-(ethylene decanoate), copoly(ethylene fumarate)-(ethylene dodecanoate) and combinations thereof. In embodiments, a suitable crystalline polyester polymer may be composed of ethylene glycol and a mixture of dodecanedioic acid and fumaric acid comonomers.

The crystalline polyester polymer can possess any of various melting points, for example, from about 30° C. to about 120° C., from about 50° C. to about 90° C. The crystalline polyester polymer may have a number average molecular weight (Mₙ), as measured, for example, by gel permeation chromatography (GPC) of, for example, from about 1,000 to about 50,000, from about 2,000 to about 25,000; and a weight average molecular weight (M_{w}) of for example, from about 2,000 to about 100,000, from about 3,000) to about 80,000, as determined by GPC. The molecular weight distribution (M_{w}/Mₙ) of the crystalline polyester polymer may be, for example, from about 2 to about 6, from about 3 to about 5.

The crystalline polyester polymer may be present, for example, in an amount of from about 3.5 to about 9.5% by weight of the toner particle, from about 4.5 to about 8.5% by weight of the toner particle, from about 5.5 to about 7.5% by weight of the toner particle, see, for example, U.S. Publ. No. 20060222991.

iii. Amorphous Polyester Polymers

Suitable amorphous polyester polymers include polyamides, polyimides, polyolefins, polyethylenes, polybutylenes, polyisobutyrates, ethylenepropylene copolymers, ethylene-vinyl acetate copolymers, polypropylenes, combinations thereof and the like. Amorphous polyester polymers also include alkali sulfonated polyester polymers, branched alkali sulfonated polyester polymers, alkali sulfonated polyimide polymers and branched alkali sulfonated polyimide polymers. Alkali sulfonated polyester polymers may be useful in embodiments, such as, the metal or alkali salts of copoly(ethylene terephthalate)-(ethylene 5-sulfo-isophthalate), copoly(propylene terephthalate)-(propylene 5-sulfo-isophthalate), copoly(diethylene terephthalate)-(diethylene 5-sulfo-isophthalate), copoly(propylene diethylene terephthalate)-(propylene diethylene 5-sulfo-isophthalate), copoly(propylene butylene terephthalate)-(propylene butylene 5-sulfo-isophthalate), combinations thereof and so on.

In embodiments, an unsaturated, amorphous polyester polymer may be used. Examples of such polyesters include those disclosed in U.S. Pat. No. 6,063,827, the disclosure of which hereby is incorporated by reference in entirety. Exemplary unsaturated amorphous polyester polymers include, but are not limited to, poly(propoxylated bisphenol cofumarate), poly(ethoxylated bisphenol cofumarate), poly(butyloxylated bisphenol cofumarate), poly(copropoxylated bisphenol co-ethoxylated bisphenol cofumarate), poly(1,2-propylene fumarate), poly(propoxylated bisphenol comaleate), poly(ethoxylated bisphenol comaleate), poly(butyloxylated bisphenol comaleate), poly(copropoxylated bisphenol co-ethoxylated bisphenol comaleate), poly(1,2-propylene maleate), poly(propoxylated bisphenol co-itaconate), poly(ethoxylated bisphenol co-itaconate), poly(butyloxylated bisphenol co-itaconate), poly(copropoxylated bisphenol co-ethoxylated bisphenol co-itaconate), poly(1,2-propylene itaconate) and combinations thereof.

The amorphous polyester polymer may be present, for example, in an amount of at least about from about 69.5 wt % to about 75.5 wt %, from about 70.5 wt % to about 74.5 wt %, from about 71.5 wt % to about 73.5 wt % of a toner particle, see, for example, U.S. Publ. No. 20060222991.

2. Colorants for Magenta Toner

Toners of the instant disclosure relate to hyperpigmented magenta loners that have, approximate or have about the same properties as that of current conventional magenta toner. For the purposes of the instant disclosure, a, “conventional magenta toner,” is one with a 1:1 weight ratio of PR122 to PR269, with each pigment present at 4.5 wt % of the toner particle. For the purposes of the instant disclosure, a, “conventional hyperpigmented magenta toner,” is one with a 1:1 weight ratio of PR122 to PR269 with each pigment present at 6.525 wt % of the toner particle.

The hyperpigmented magenta toner of interest with a total pigment loading of 1.31 times (11.8 wt % total pigment) that of a conventional magenta toner and a PR122/PR269 ratio of 56/44, has color virtually indistinguishable from conventional magenta loner (a ΔE₂₀₀₀ of less than about 1.9, less than about 1.8, less than about 1.7, where a ΔE₂₀₀₀ of about 3 or lower is considered a difference between colors indistinguishable to the human eye) when the toner is presented on Digital Color Elite Gloss® (DCEG) (Xerox) 120 gsm (or g/m²) paper. That is improved over the current conventional hyperpigmented magenta toner with a 1.45× amount of pigments in a 1:1 ratio which has a ΔE₂₀₀₀ greater than 2 when compared to conventional magenta toner.

As a means to assess rapidly the approximate similarity of toners or colors, a wet deposition (‘wet-dep’) method can be used, for example, wherein known quantities of an aqueous suspension of toner (e.g., ˜150-400 mg/L) are filtered through a nitrocellulose membrane. The filter is dried leaving a patch of deposited toner at a known TMA. The filter then is protected with Mylar and passed through a laminator to fuse the toner to the membrane, providing a smooth and glossy sample. The color sample can be read in a spectrophotometer to provide CIELAB values.

Alternatively, for example, machine prints, for example, using half toning with PR122 and PR269 in separate developer housings, can be made to determine color similarities and pigment ratios. Thus, a two dimensional grid of samples using predetermined, varying amounts of each pigment per sample are applied to a substrate to form a color sample array of cells each with a varying amount of one or both of the pigments, the individual samples of the array are examined, for example, determining the L*, a* and b* values for each sample, calculating an error factor for each sample and correlating similarity based on an error or variability factor to the known ratios and amounts of red and purple pigments contained in each sample.

Suitable amounts of each of the red and purple pigments in a magenta toner can be selected by assessing the ΔE₂₀₀₀ difference of candidate toners of interest as compared to the conventional magenta toner using, for example, a machine or a device and a receiving medium or substrate in and for which the toner will be used. Hence, a commercially available photocopier using, for example, standard paper can be used. Then, as known in the art, a CIELAB a*-b* plot is obtained for a composition and the ΔE₂₀₀₀ value is determined using a known fitting function to reveal similarity to conventional magenta toner.

Toners of the present disclosure may be applied at a TMA of no more than about 0.40 mg/cm², no more than 0.375 mg/cm², no more than about 0.35 mg/cm² or lower.

PR122 is present at about 6.6% by solids weight of the toner formulation and PR269 pigment is present at about 5.2% by solids weight of the toner formulation, and the weight ratio of PR122:PR269 is 56:44.

As known in the art and as taught herein, hue, color, ΔE₂₀₀₀ value and so on can vary, depending on, for example, the receiving member, level of gloss, deposition method. TMA, whether the pigments are applied separately or premixed in a single developer and so on. Hence, the actual pigment amounts above may vary depending on such factors and can be optimized as taught herein for the intended use. Thus, for example, because TMA values can impact ΔE₂₀₀₀, toner amounts deposited can be adjusted to obtain TMA values suitable to obtain a magenta toner of interest.

3. Optional Components

a. Surfactants

In embodiments, toner compositions may be in dispersions including surfactants. Moreover, toner particles may be formed by emulsion aggregation methods where the polymer and other components of the toner are in combination with one or more surfactants to form an emulsion.

One, two or more surfactants may be used. The surfactants may be selected from ionic surfactants and nonionic surfactants, or combinations thereof. Anionic surfactants and cationic surfactants are encompassed by the term, “ionic surfactants.” In embodiments, the total amount of surfactants may be in an amount of from about 0.01% to about 5% by weight of the toner-forming composition, from about 0.75% to about 4% by weight of the toner-forming composition, from about 1% to about 3% by weight of the toner-forming composition.

Examples of nonionic surfactants include, for example, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether and dialkylphenoxy poly(ethyleneoxy) ethanol, for example, available from Rhone-Poulenc as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™. Other examples of suitable nonionic surfactants include a block copolymer of polyethylene oxide and polypropylene oxide, including those commercially available as SYNPERONIC® PR/F, in embodiments, SYNPERONIC® PR/F 108; and DOWFAX, available from The Dow Chemical Corp.

Anionic surfactants include sulfates and sulfonates, such as, sodium dodecylsulfate (SDS), sodium dodecylbenzene sulfonate, sodium dodecylnaphthalene sulfate and so on; dialkyl benzenealkyl sulfates; acids, such as, palmitic acid, and NEOGEN or NEOGEN SC obtained from Daiichi Kogyo Seiyaku, and so on, combinations thereof and the like. Other suitable anionic surfactants include, in embodiments, alkyldiphenyloxide disulfonates or TAYCA POWER BN2060 from Tayca Corporation (Japan), which is a branched sodium dodecyl benzene sulfonate. Combinations of those surfactants and any of the foregoing nonionic surfactants may be used in embodiments.

Examples of cationic surfactants include, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, trimethyl ammonium bromides, halide salts of quarternized polyoxyethylalkylamines, dodecylbenzyl triethyl ammonium chlorides, MIRAPOL® and ALKAQUAT® available from Alkaril Chemical Company, SANISOL® (benzalkonium chloride) available from Kao Chemicals and the like, and mixtures thereof, including, for example, a nonionic surfactant as known in the art or provided hereinabove.

b. Waxes

The toners of the instant disclosure, optionally, may contain a wax, which can be either a single type of wax or a mixture of two or more different types of waxes (hereinafter identified as, “a wax”). When included, the wax may be present in an amount of, for example, from about 6 weight % to about 12 weight % of the toner particles, from about 7 weight % to about 11 weight % of the toner particles, from about 8 to about 10 wt %. Waxes that may be selected include waxes having, for example, a weight average molecular weight of from about 500 to about 20,0000, from about 1,000 to about 10,000.

Waxes that may be used include, for example, polyolefins, such as, polyethylene, polypropylene and polybutene waxes, such as, those that are commercially available, for example, POLYWAX™ polyethylene waxes from Baker Petrolite, wax emulsions available from Michaelman, Inc. or Daniels Products Co., EPOLENE N15™ which is commercially available from Eastman Chemical Products, Inc., VISCOL 550-P™, a low weight average molecular weight polypropylene available from Sanyo Kasei K. K.; plant-based waxes, such as carnauba wax, rice wax, candelilla wax, sumac wax and jojoba oil; animal-based waxes, such as beeswax; mineral-based waxes and petroleum-based waxes, such as montan wax, ozokerite, ceresin wax, paraffin wax, microcrystalline wax and Fischer-Tropsch waxes; ester waxes obtained from higher fatty acids and higher alcohols, such as stearyl stearate and behenyl behenate; ester waxes obtained from higher fatty acids and monovalent or multivalent lower alcohols, such as butyl stearate, propyl oleate, glyceride monostearate, glyceride distearate and pentaerythritol tetrabehenate; ester waxes obtained from higher fatty acids and multivalent alcohol multimers, such as diethyleneglycol monostearate, dipropyleneglycol distearate, diglyceryl distearate and triglyceryl tetrastearate; sorbitan higher fatty acid ester waxes, such as sorbitan monostearate; cholesterol higher fatty acid ester waxes, such as, cholesteryl stearate, and so on.

Examples of functionalized waxes that may be used include, for example, amines and amides, for example, AQUA SUPERSLIP 6550™ and SUPERSLIP 6530™ available from Micro Powder Inc.; fluorinated waxes, for example, POLYFLUO 190™, POLYFLUO 200™, POLYSILK 19™ and POLYSILK 14™ available from Micro Powder Inc.; mixed fluorinated amide waxes, for example, MICROSPERSION 19™ also available from Micro Powder Inc.; imides, esters, quaternary amines, carboxylic acids, acrylic polymer emulsions, for example, JONCRYL 74™, 89™, 130™, 537™ and 538™ available from SC Johnson Wax; and chlorinated polypropylenes and polyethylenes available from Allied Chemical, Petrolite Corp. and SC Johnson. Mixtures and combinations of the foregoing waxes also may be used in embodiments.

B. Toner Particle Preparation

1. Method

a. Particle Formation

The toner particles may be prepared by any method within the purview of one skilled in the art, for example, any of the emulsion/aggregation methods can be used as the pigments of interest are compatible with those methods. However, any suitable method of preparing toner particles may be used, including chemical processes, such as suspension and encapsulation processes disclosed, for example, in U.S. Pat. Nos. 5,290,654 and 5,302,486, the disclosure of each of which hereby is incorporated by reference in entirety: by conventional granulation methods, such as, jet milling; pelletizing slabs of material; other mechanical processes: any process for producing nanoparticles or microparticles; and so on.

In embodiments, toner compositions may be prepared by emulsion/aggregation processes, such as, a process that includes aggregating a mixture of a resin-forming material, the pigments of interest, an optional wax and any other desired reagents in an emulsion, optionally, with surfactants as described above, and then optionally coalescing the aggregate mixture. A mixture may be prepared by adding an optional wax or other materials, which optionally, also may be in a dispersion, including a surfactant, to the emulsion comprising a resin-forming material and the pigments of interest, which may be a mixture of two or more emulsions containing the requisite reagents. The pH of the resulting mixture may be adjusted with an acid, such as, for example, acetic acid, nitric acid or the like. In embodiments, the pH of the mixture may be adjusted to from about 2 to about 4.5. Additionally, in embodiments, the mixture may be homogenized.

b. Aggregation

Following preparation of the above mixture, often, it is desirable to form larger particles or aggregates. An aggregating agent may be added to the mixture. Suitable aggregating agents include, for example, aqueous solutions of a divalent cation, a multivalent cation or a compound comprising same. The aggregating agent may be, for example, a polyaluminum halide, such as, polyaluminum chloride (PAC) or the corresponding bromide, fluoride or iodide; a polyaluminum silicate, such as, polyaluminum sulfosilicate (PASS); or a water soluble metal salt, including, aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate or combinations thereof.

In embodiments, the aggregating agent may be added to the mixture at a temperature that is below the glass transition temperature (T) of the resin or of a polymer.

The aggregating agent may be added to the mixture components to form a toner in an amount of, for example, from about 0.1 part per hundred (pph) to about 1 pph, from about 0.25 pph to about 0.75 pph.

To control aggregation of the particles, the aggregating agent may be metered into the mixture over time. For example, the agent may be added incrementally into the mixture over a period of from about 5 to about 240 minutes, from about 30 to about 200 minutes.

Addition of the aggregating agent also may be done while the mixture is maintained under stirred conditions, in embodiments, from about 50 rpm to about 1,000 rpm, from about 100 rpm to about 500 rpm; and at a temperature that is below the T_{g} of the resin or polymer, from about 30° C. to about 90° C., from about 35° C. to about 70° C. The growth and shaping of the particles following addition of the aggregation agent may be accomplished under any suitable conditions.

The particles may be permitted to aggregate until a predetermined desired particle size is obtained. Particle size can be monitored during the growth process. For example, samples may be taken during the growth process and analyzed, for example, with a COULTER COUNTER®, for average particle size.

Once the desired final size of the toner particles or aggregates is achieved, the pH of the mixture may be adjusted with base or buffer to a value of from about 6 to about 10, from about 6 to about 9. The adjustment of pH may be used to freeze, that is, to stop, toner particle growth. The base used to stop toner particle growth may be, for example, an alkali metal hydroxide, such as, for example, sodium hydroxide, potassium hydroxide, ammonium hydroxide, combinations thereof and the like. In embodiments, a chelating agent, such as, EDTA, may be added to assist adjusting the pH to the desired value.

The characteristics of the toner particles may be determined by any suitable technique and apparatus. Volume average particle diameter and geometric standard deviation may be measured using an instrument, such as, a Beckman Coulter MULTISIZER® 3.

In embodiments, the aggregate particles may be of a size of less than about 5 μm, less than about 4 μm, less than about 3 μm.

c. Shells

In embodiments, an optional shell may be applied to the formed toner particles, aggregates or coalesced particles. Any polymer described above as suitable for the core, may be used for the shell. The shell polymer may be applied to the particles or aggregates by any method within the purview of those skilled in the art.

In embodiments, an amorphous polyester may be used to form a shell over the particles or aggregates to form toner particles or aggregates having a core-shell configuration. In embodiments, an LMW amorphous polyester may be used to form a shell over the particles or aggregates.

The shell polymer may be present in an amount of from about 10% to about 40% by weight of the toner particles or aggregates, from about 15% to about 35% by weight of the toner particles or aggregates.

d. Coalescence

As toner aggregates may be erose, irregular in size or irregular in shape, it may be desirable to conduct an additional step to form more regular particles.

Such a process is known in the art as coalescence, see, for example, U.S. Pat. No. 7,736,831, to produce more regular, spherical particles, which can be implemented, for example, by incubating the toner particles at an elevated temperature, employing a compound to facilitate coalescence or both.

Examples of suitable coalescence agents include, but are not limited to, benzoic acid alkyl esters, ester alcohols, glycol/ether-type solvents, long chain aliphatic alcohols, aromatic alcohols, mixtures thereof and the like.

The coalescence agent can be added prior to the coalescence or fusing step in any desired or suitable amount. For example, the coalescence agent can be added in an amount of from about 0.01 to about 10% by weight, based on the solids content in the reaction medium.

Coalescence can be achieved by, for example, heating the mixture to a temperature of from about 55° C. to about 100° C., from about 65° C. to about 75° C. which may be below the melting point of the resin or polymer(s) to prevent plasticization. Higher or lower temperatures may be used, it being understood that the temperature is a function of the polymer(s) used for the resin and/or shell. Coalescence may proceed and be accomplished over a period of from about 0.1 to about 9 hours, from about 0.5 to about 4 hours.

After coalescence, the mixture may be cooled to room temperature, such as, from about 20° C. to about 25° C. The cooling may be rapid or slow, as desired. After cooling, the toner particles optionally may be washed with water and then dried.

e. Optional Additives

In embodiments, the toner particles also may contain one or more optional additives. Hence, external additive particles including flow aid additives, which additives may be present on the surface of the toner particles, can be included with the finished developer. Examples of such additives include metal oxides, such as, titanium oxide, tin oxide, mixtures thereof and the like; colloidal silicas, such as, AEROSIL®, metal salts and metal salts of fatty acids, including zinc stearate, aluminum oxides, cerium oxides and mixtures thereof; and so on, as known in the art. Each of the external additives may be present in embodiments in amounts of from about 0.1 to about 5 weight %, from about 0.1 to about 1 weight %, of the toner. Several of the aforementioned additives are illustrated in U.S. Pat. Nos. 3,590,000, 3,800,588, and 6,214,507, the disclosure of each of which is incorporated herein by reference.

i. Charge Additives

The toner may include any known charge additives in amounts of from about 0.1 to about 10 weight %, from about 0.5 to about 7 weight % of the toner. Charge enhancing molecules can impart ether a positive or a negative charge on a toner particle. Examples of such charge additives include alkyl pyridinium halides, bisulfates, the charge control additives of U.S. Pat. Nos. 3,944,493; 4,007,293; 4,079,014; 4,394,430; and 4,560,635, the disclosure of each of which hereby is incorporated by reference in entirety, negative charge enhancing additives, such as, aluminum complexes, and the like. Examples include quaternary ammonium compounds, see, for example, U.S. Pat. No. 4,298,672, organic sulfate and sulfonate compounds, see for example, U.S. Pat. No. 4,338,390, cetyl pyridinium tetrafluoroborates, distearyl dimethyl ammonium methyl sulfate, aluminum salts and so on.

ii. Surface Modifications

Surface additives can be added to the toner compositions of the present disclosure, for example, after washing or drying. Examples of such surface additives include, for example, one or more of a metal salt, a metal salt of a fatty acid, a colloidal silica, a metal oxide, such as, TiO₂ (for example, for improved relative humidity (RH) stability, tribo control and improved development and transfer stability), an aluminum oxide, a cerium oxide, a strontium titanate, SiO₂, mixtures thereof and the like. Examples of such additives include those disclosed in U.S. Pat. Nos. 3,590,000; 3,720,617; 3,655,374; and 3,983,045, the disclosure of each of which hereby is incorporated by reference in entirety.

Surface additives may be present in an amount of from about 0.1 to about 10 weight %, from about 0.5 to about 7 weight % of the toner.

Other additives include lubricants, such as, a metal salt of a fatty acid (e.g., zinc or calcium stearate) or long chain alcohols, such as, UNILIN 700 available from Baker Petrohte and AEROSIL R972® available from Degussa. The coated silicas of U.S. Pat. Nos. 6,190,815 and 6,004,714, the disclosure of each of which hereby is incorporated by reference in entirety, also can be present. The additive can be present in an amount of from about 0.05 to about 5%, from about 0.1 to about 2% of the toner, which additives can be added during the aggregation or blended into the formed toner product.

The gloss of a toner may be influenced by the resin, such as, a polymer comprising a styrene, an acrylate or both, or the amount of retained metal ion, such as, Al³⁺, in a particle. The amount of retained metal ion may be adjusted further by the addition of a chelator, such as, EDTA. In embodiments, the amount of retained metal ion, for example, Al³⁺, in toner particles of the present disclosure may be from about 0.1 pph to about 1 pph, from about 0.25 pph to about 0.8 pph. The gloss level of a toner of the instant disclosure may have a gloss of from about 20 gu to about 100 gu, measured using a commercially available gloss meter (for example, BYK-Gardner, Geretsried, DE).

The dry toner particles, exclusive of external surface additives, may have the following characteristics: (1) volume average diameter (also referred to as “volume average particle diameter”) of less than about 7 μm, less than about 6 μm, less than about 5 μm; (2) number average geometric standard deviation (GSDn) and/or volume average geometric standard deviation (GSDv) of from about 1.18 to about 1.30, from about 1.21 to about 1.24; and (3) circularity of from about 0.9 to about 1.0 (measured with, for example, a Sysmex FPIA 2100 analyzer).

### III. Developers

A. Composition

The toner particles thus formed may be formulated into a developer composition. For example, the toner particles may be mixed with carrier particles to achieve a two component developer composition. The toner concentration in the developer may be from about 1% to about 25% by weight of the total weight of the developer with the remainder of the developer composition being the carrier. However, different toner and carrier percentages may be used to achieve a developer composition with desired characteristics.

1. Carrier

Examples of carrier particles for mixing with the toner particles include those particles that are capable of triboelectrically obtaining a charge of polarity opposite to that of the toner particles. Illustrative examples of suitable carrier particles include granular zircon, granular silicon, glass, steel, nickel, ferrites, iron ferrites, silicon dioxide, one or more polymers and the like. Other carriers include those disclosed in U.S. Pat. Nos. 3,847,604; 4,937,166; and 4,935,326.

In embodiments, the carrier particles may include a core with a coating thereover, which may be formed from a polymer or a mixture of polymers that are not in close proximity thereto in the triboelectric series, such as, those as taught herein or as known in the art. The coating may include fluoropolymers, terpolymers ofstyrene, silanes and the like. The coating may have a coating weight of, for example, from about 0.1 to about 10% by weight of the carrier.

Various effective suitable means can be used to apply the polymer to the surface of the carrier core, for example, cascade roll mixing, tumbling, milling, shaking, electrostatic powder cloud spraying, fluidized bed mixing, electrostatic disc processing, electrostatic curtain processing, combinations thereof and the like. The mixture of carrier core particles and polymer then may be heated to enable the polymer to melt and to fuse to the carrier core. The coated carrier particles then may be cooled and thereafter classified to a desired particle size.

### IV. Devices Comprising a Magenta Toner Particle

Toners and developers can be combined with a number of devices ranging from enclosures or vessels, such as, a vial, a bottle, a flexible container, such as a bag or a package, and so on, to devices that serve more than a storage function.

A. Imaging Device Components

The toner compositions and developers of interest can be incorporated into devices dedicated, for example, to delivering same for a purpose, such as, forming an image. Hence, particularized toner delivery devices are known, see, for example, U.S. Pat. No. 7,822,370, and can contain a toner preparation or developer of interest. Such devices include cartridges, tanks, reservoirs and the like, and can be replaceable, disposable or reusable. Such a device can comprise a storage portion; a dispensing or delivery portion; and so on; along with various ports or openings to enable toner or developer addition to and removal from the device; an optional portion for monitoring amount of toner or developer in the device: formed or shaped portions to enable siting and seating of the device in, for example, an imaging device; and so on.

B. Toner or Developer Delivery Device

A toner or developer of interest may be included in a device dedicated to delivery thereof, for example, for recharging or refilling toner or developer in an imaging device component, such as, a cartridge, in need of toner or developer, see, for example, U.S. Pat. No. 7,817,944, wherein the imaging device component may be replaceable or reusable.

### V. Imaging Devices

The toners or developers can be used for electrostatographic or electrophotographic processes, including those disclosed in U.S. Pat. No. 4,295,990, the disclosure of which hereby is incorporated by reference in entirety. In embodiments, any known type of image development system may be used in an image developing device, including, for example, magnetic brush development, jumping single component development, hybrid scavengeless development (HSD) and the like. Those and similar development systems are within the purview of those skilled in the art.

The following Examples illustrate embodiments of the instant disclosure. The Examples are intended to be illustrative only and are not intended to limit the scope of the present disclosure. Parts and percentages are by weight unless otherwise indicated. As used herein, “room temperature,” (RT) refers to a temperature of from about 20° C. to about 30° C.

### Examples

Three toners were prepared using commercially available reagents. The composition of the toners is provided in the table below.

It was observed through testing on a Color Press 1000 (Xerox Corp) photocopier that the conventional HY magenta toner with a pigment load 1.45 times that of conventional magenta toner (or 13.05 pph total pigment content with a 1:1 ratio of PR122 and PR269) applied at a TMA of 0.35 mg/cm² exhibited a significant color shift relative to the standard conventional magenta toner with 9 pph total pigment content and a 1:1 ratio of the two pigments at a TMA of 0.45 mg/cm², the ΔE₂₀₀₀ was approximately 6 on DCEG 120 gsm paper.

The HY magenta toner of interest with a 56/44 ratio of PR122/PR269 with a total pigment load of 11.8 wt % (1.31 times the pigment amount of conventional magenta toner) applied at 0.35 mg/cm² TMA exhibited insignificant color shift relative to the standard conventional magenta toner applied at 0.45 mg/cm², the ΔE₂₀₀₀ was 1.7 on DCEG 120 gsm paper.

TABLE 1
Components of Magenta Toners

| | Conventional | Conventional HY | HY Magenta |
|---|---|---|---|
| | Magenta | Magenta Toner | Toner |
| Component | Toner | (1.45X, 50:50) | (1.31X, 56:44) |
| LMW amorphous | 37.7% | 42.775% | 43.6% |
| polyester | | | |
| HMW amorphous | 37.7% | 28.575% | 29.0% |
| polyester | | | |
| Crystalline polyester | 6.6% | 6.6% | 6.6% |
| Polyethylene wax | 9.0% | 9.0% | 9.0% |
| PR122 | 4.5% | 6.525% | 6.6% |
| PR269 | 4.5% | 6.525% | 5.2% |

It will be appreciated that various of the above-disclosed and other features and functions, or alternatives thereof, may be desirably combined into many other different systems or applications. Also various presently unforeseen or unanticipated alternatives, modifications, variations or improvements therein may be subsequently made by those skilled in the art, which are also intended to be encompassed by the following claims. Unless specifically recited in a claim, steps or components of claims should not be implied or imported from the specification or any other claims as to any particular order, number, position, size, shape, angle, color or material.

All references cited herein are herein incorporated by reference in entirety.

1. A toner, comprising:
at least one resin; and
colorants consisting of pigment red (PR) 122, present at 6.6% by solids weight of a toner formulation and PR 269, present at 5.2% by solids weight of a toner formulation, wherein PR 122 and PR 269 are present in a ratio of 56:44 by weight and a total colorant amount of 11.8 wt %,
wherein an image comprising said toner in a toner mass area (TMA) of 0.35 mg/cm² when compared to an image comprising a magenta toner consisting of 9 wt % total pigment in a 50:50 weight ratio of PRI22:PR269 in a TMA of 0.45 mg/cm² comprises a ΔE₂₀₀₀ of less than about 2.

2. The toner of claim 1, wherein the at least one resin comprises a styrene resin, an acrylate resin, a methacrylate resin, a butadiene resin, an isoprene resin, an acrylic acid resin, a methacrylic acid resin, an acrylonitrile resin or combinations thereof.

3. The toner of claim 1, wherein the at least one resin comprises a polyester resin.

4. The toner of claim 3, wherein said polyester resin comprises two amorphous resins.

5. The toner of claim 3, wherein said polyester resin comprises an amorphous polyester resin and a crystalline polyester resin.

6. The toner of claim 4, wherein the two amorphous polyester resin is are in an amount from about 69.5 wt % to about 75.5 wt %.

7. The toner of claim 5, wherein the crystalline resin in an amount from about 3.5 wt % to about 9.5 wt %.

8. The toner of claim 4, wherein said two amorphous resins comprise a high molecular weight (HMW) resin.

9. The toner of claim 4, wherein said two amorphous resins comprise a low molecular weight (LMW) resin.

10. The toner of claim 8, wherein said HMW resin is in an amount from about 26 wt % to about 32 wt %.

11. The toner of claim 9, wherein said LMW resin is in an amount from about 41 wt % to about 46 wt %.

12. The toner of claim 1, comprising a wax.

13. The toner of claim 12, wherein said wax comprises a polyethylene wax.

14. The toner of claim 12, wherein said wax is in an amount from about 6 wt % to about 12 wt %.

15. The toner of claim 1, comprising an HMW amorphous polyester resin, an LMW amorphous polyester resin, a crystalline polyester resin and a wax.

16. The toner of claim 1, wherein the toner is an emulsion/aggregation toner.

17. The toner of claim 1, wherein the toner comprises a shell.

18. A developer comprising the toner of claim 1.

19. The developer of claim 18, further comprising a carrier.

20. The developer of claim 19, wherein said carrier comprises a coating.
